(19) United States
(12) Patent Application Publication
(10) Pub. No.: US 2024/0367601 A1
(43) Pub. Date: Nov. 7, 2024

(54) BUMPER SYSTEM AND A DEVICE HAVING THE SAME

(71) Applicant: LIONSBOT INTERNATIONAL PTE. LTD., Singapore (SG)

(72) Inventor: Wai Peng Benjamin CHAY, Singapore (SG)

(73) Assignee: LIONSBOT INTERNATIONAL PTE. LTD., Singapore (SG)

(21) Appl. No.: 18/687,918

(22) PCT Filed: Mar. 15, 2022
(86) PCT No.: PCT/SG2022/050134

§ 371 Date: Feb. 29, 2024

(51) Int. Cl. B60R 19/24; B60R 21/01

(52) U.S. Cl. CPC B60R 19/24; B60R 2021/01006

(57) ABSTRACT

A bumper system is disclosed. The bumper includes a support having one or more first members. The bumper further includes a bumper having one or more second members. The bumper being maintainable by the support in a rest position with respect to the support due to magnetic attraction between the one or more first members and the one or more second members when no force is applied to the bumper. The bumper is dislodgeable from the rest position towards the support when a force is applied to the bumper. When the force is removed from the bumper. the magnetic attraction between the one or more first members and the one or more second members returns the bumper to the rest position. The bumper system further includes one or more sensors mounted to either the support or the bumper for detecting dislodgement of the bumper from the rest position. A device including the bumper system is also disclosed.

### TECHNICAL FIELD

This invention relates to a bumper system. More particularly, this invention relates to a bumper system for use on a robotic device.

### BACKGROUND

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

Bumper mechanisms in any kind of robot or device often include mechanical springs in different forms. The springs may include an extension spring, a compression spring and a spring made of spring steel. However, such bumper mechanisms only allow compression in one single direction. To allow compression in more than one direction, i.e. in multiple directions, a bumper mechanism could be made using different springs mounted on different planes so that the bumper mechanism can compress in many different directions and still return to the same origin. Such a bumper mechanism is typically complicated in design and has many moving parts. As a result, it is more prone to failure and is expensive.

To mitigate this problem, different solutions have been proposed. One such solution is disclosed in U.S. Pat. No. 6,739,635, Byun, entitled “Bumper Device For Automated Guided Vehicle”. The bumper device for an Automated Guided Vehicle (AGV) includes a bumper supporting member combined to a vehicle body of the AGV, and a bumper supported on the bumper supporting member. The bumper device also Includes a movement supporting device installed at the bumper supporting member and to movably support the bumper, and a movement sensor to sense a movement of the bumper. Thus, the bumper device promptly senses and effectively absorbs an impact from multiple directions. Such a solution is nevertheless still complicated in design and expensive to build.

There is therefore a need for a bumper system which addresses, at least in part, one or more of the forgoing problems.

### SUMMARY

According to an aspect of the present disclosure, there is provided a bumper system. The bumper includes a support having one or more first members. The bumper further includes a bumper having one or more second members. The bumper being maintainable by the support in a rest position with respect to the support due to magnetic attraction between the one or more first members and the one or more second members when no force is applied to the bumper. The bumper is dislodgeable from the rest position towards the support when a force is applied to the bumper. When the force is removed from the bumper, the magnetic attraction between the one or more first members and the one or more second members returns the bumper to the rest position. The bumper system further includes one or more sensors mounted to either the support or the bumper for detecting dislodgement of the bumper from the rest position.

In some embodiments of the bumper system, the bumper includes a mount having the one or more second members, and a plate detachably mounted to the mount.

In some embodiments of the bumper system, the plate is detachably mounted to the mount via one or more magnets on either the mount or the plate.

In some embodiments of the bumper system, the bumper system has a central axis, wherein the one or more first members includes four first members, and the one or more second members includes four second members. Two of the four first members are positioned on either side of the central axis on a first surface of the support. And the other two of the four first members are positioned on either side of the central axis on a second surface of the support opposite the first surface. The four second members are positioned on the bumper such that they interact with the four first members to allow the bumper to be maintained in the rest position.

In some embodiments of the bumper system, the one or more sensors includes two sensors positioned on either side of the central axis on the support or the bumper. Both sensors are actuatable when the force is applied to a medial position of the bumper, and only one sensor is actuatable when the force is applied to a side of the bumper.

In some embodiments of the bumper system, the two sensors are mounted to surfaces of either the support or the bumper that are angularly inclined with respect to the central axis.

In some embodiments of the bumper system, movement of the bumper with respect to the support is restricted to ensure that when the force is removed from the bumper, there is sufficient magnetic attraction between the at least one first member and the at least one second member to return the bumper to the rest position.

In some embodiments of the bumper system, either the support or the bumper includes a cavity therein and the other of the support and the bumper includes a projection that projects into the cavity and movement of the projection is restricted to within a boundary of the cavity to thereby restrict movement of the bumper with respect to the support.

In some embodiments of the bumper system, one or both of the first member and the second member is a magnet.

In some embodiments of the bumper system, the magnet is of about N45 maximum energy product.

According to another aspect of the present disclosure, there is provided a device to which a bumper system according to any embodiment described above may be mounted. The device may be a robot, a self-driving vehicle, an automated guided vehicle, a car, an automatic door, a tactile floor depression sensing device, or a production line conveyor belt.

Other aspects and advantages of the invention will become apparent from the following detailed description, taken in conjunction with the accompanying drawings, illustrating by way of example the principles of the invention.

### BRIEF DESCRIPTION OF DRAWINGS

The invention will be better understood with reference to the drawings, in which:

FIG. 1 is an exploded isometric drawing of a bumper system including a support, a mount and a bumper plate according to an embodiment;

FIG. 2 is side view of the bumper system in FIG. 1 as seen in the direction of an arrow A in FIG. 1;

FIG. 3 is a plan view of the bumper system in FIG. 1 shown in an assembled state;

FIG. 4 is cross-sectional drawing of the bumper system in FIG. 3 taken along line A-A in FIG. 3; and

FIG. 5 is an isometric drawing of a robotic device to which the bumper system in FIG. 1 is mounted.

### DETAILED DESCRIPTION OF THE EMBODIMENTS

Throughout this document, unless otherwise indicated to the contrary, the terms “comprising”, “consisting of”, “having” and the like, are to be construed as non-exhaustive, or in other words, as meaning “including, but not limited to.”

Furthermore, throughout the specification, unless the context requires otherwise, the word “include” or variations such as “includes” or “including” will be understood to imply the inclusion of a stated integer or group of integers but not the exclusion of any other integer or group of integers.

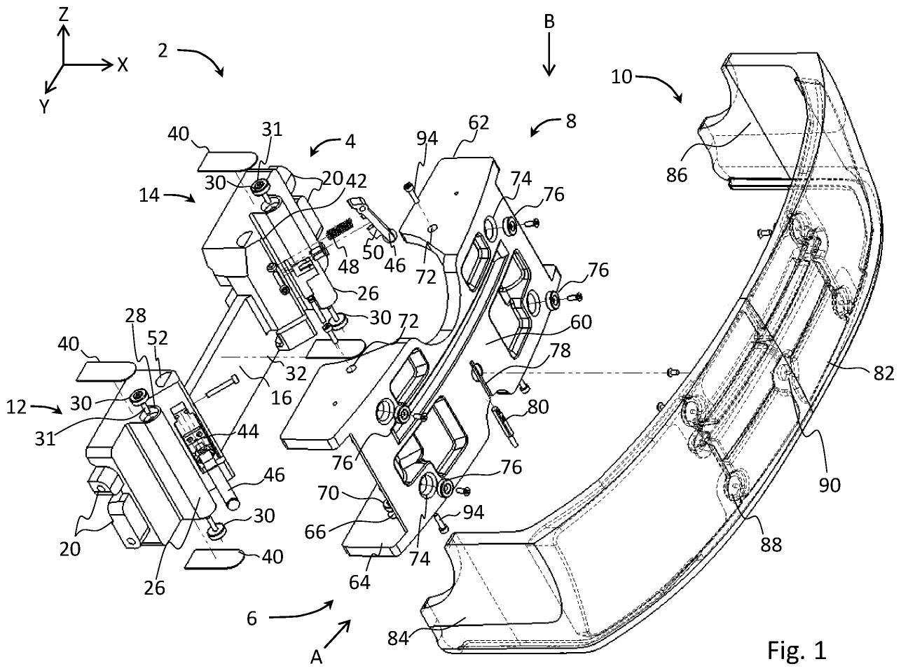

The following description refers to elements or parts being “coupled” together. As used herein, unless expressly stated otherwise, “coupled” means that one element/part is directly or indirectly joined to another element/part, and does not necessarily refer to a direct mechanical connection. Coupled elements/parts are understood to exert mutual influence on one another. Thus, although FIG. 1 depicts one exemplary arrangement of elements, additional intervening elements, devices, features, or components may be present in an embodiment of the depicted subject matter.

In addition, certain terminology may also be used in the following description for the purpose of reference only, and thus are not intended to be limiting. For example, terms such as “upper”, “lower”, “above”, and “below” refer to directions in the drawings to which reference is made in a consistent but arbitrary frame of reference. Such terminology may include the words specifically mentioned above, derivatives thereof, and words of similar import. Similarly, the terms “first”, “second”, and other such numerical terms referring to structures do not imply a sequence or order unless clearly indicated by the context.

Unless defined otherwise, all technical and scientific terms used herein have the same meaning as is commonly understood by a skilled person to which the subject matter herein belongs.

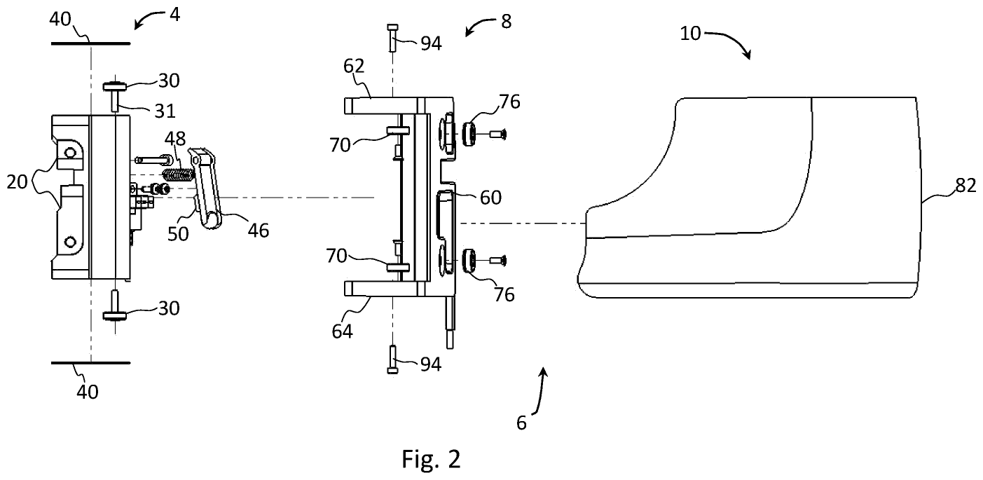

As shown in the drawings for purposes of illustration, the invention may be embodied in a simple and reliable bumper system. Existing bumper systems tend to be complicated in design and expensive. Referring to FIGS. 1 to 4, a bumper system includes a support having one or more first members, a bumper having one or more second members, and one or more sensors. The bumper is maintainable by the support in an original or rest position with respect to the support due to magnetic attraction between the one or more first members and the one or more second members when no force is applied to the bumper. The bumper is dislodgeable from the rest position towards the support when a force is applied to the bumper. When the force is removed from the bumper, the magnetic attraction between the one or more first members and the one or more second members returns the bumper to the rest position. The one or more sensors are mounted to either the support or the bumper for detecting dislodgement of the bumper from the rest position.

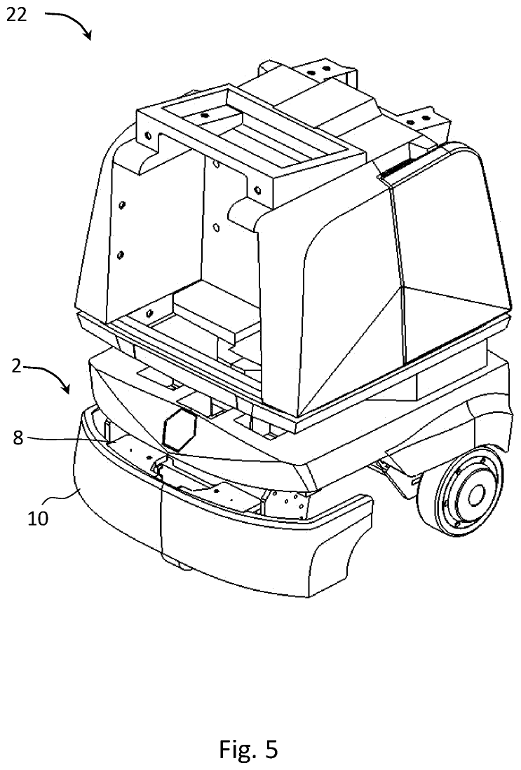

Specifically, FIGS. 1-4 show a bumper system 2 according to an embodiment of the disclosure. The bumper system 2 includes a support 4 and a bumper 6. The bumper 6 includes a mount 8 and a bumper plate 10 detachably coupled to the mount 8. The support 4 includes a first end block 12 and a second end block 14 connected to the first end block 12 by a connecting wall 16. Extending from an end of each of the first end block 12 and the second end block 14 are laterally extending protrusions 20 that allow the support 4 to be detachably mounted to a moveable device, such as a robotic device 22 as shown in FIG. 5. Each of the first end block 12 and the second end block 14 includes an elongated raised portion 26 that extends across a height of the end blocks 12, 14. On each end of the raised portion 26 is a hole 28. With the two raised portions 26 on the two end blocks 12, 14 of the support 4, there are a total of four such holes 28, two defined in an upper surface and two defined in a bottom surface thereof. The support 4 further includes four first members 30, each of which is received in one of the four holes 28. In this embodiment, each first member 30 is a countersunk disc magnet 30. Each hole 28 in the end blocks 12, 14 has a depth that is greater than a height of the countersunk disc magnet 30 such that when the disc magnet 30 is received in the hole 28 resting on a base thereof, a top surface of the disc magnet 30 is below, i.e., offset from, a surface of the end block 12, 14. The disc magnets 30 are fixed in place within the holes 28 using any appropriate fasteners such as, but not limited to, adhesives, screws, etc. As an example, countersunk screws 31 are used in this embodiment to fasten the disc magnets 30 in the holes 28. The disc magnet 30 may be of N45 maximum energy product. With a central axis 32 of the support 4 running through the connecting wall 16, two of the first set of four disc magnets 30 are positioned on either side of the central axis 32 on the upper surface of the support 4, and the other two of the first set of four disc magnets 30 are positioned on either side of the central axis 32 on the bottom surface of the support 4 opposite the top surface. Friction reducing tapes, such as but not limited to a iglidur tribo-tape is (a trademarked product available from Igus GmbH) are attached to the top and bottom surfaces of the end blocks 12, 14 to cover an opening of each hole 28. However, those skilled in the art will readily appreciate that other types of tapes or material may be applied to any part of the top and bottom surfaces to reduce friction between the support 4 and the mount 8.

Adjacent each raised portion 26 of the first and second end blocks 12, 14 is an angularly-inclined wall 42. Each angularly-inclined wall 42 includes a cavity defined therein. The angle of inclination may be approximately 45 degrees with respect to the central axis 32, although other angles will also work. Mounted in each cavity is a sensor 44 such as, but not limited to, an optoelectronic sensor 44. Two sensors 44 positioned on either side of the central axis 32 on the support 4. Pivoted to a surface of the angularly-inclined wall 42 is an actuating lever 46. The actuating lever 46 is biased by a helical spring 48 seated in the cavity to be proud of the angularly-inclined wall 42. The actuating lever 46 may be pushed, against a force of the helical spring 48 to move towards the optoelectronic sensor 44 in the cavity. As known to those skilled in the art, the optoelectronic sensor 44 includes a light transmitter and a light receiver opposite the light receiver. The light transmitter may be activated to send light pulses to the light receiver. When the actuating lever is biased away from the optoelectronic sensor 44, the light pulses emitted by the light transmitter are received by the light receiver. When the actuating lever 46 is pushed towards the optoelectronic sensor 44, a flap 50 projecting from a distal end of the actuating lever 46 will go between the light transmitter and the light receiver to block light emitted from the light transmitter so that it is not received by the light receiver. In this manner, the optoelectronic sensor 44 can be used to detect the position of the actuating lever 46, whether it is away from the optoelectronic sensor 44 or pushed against the optoelectronic sensor 44. On the top and bottom surfaces of the first and second end blocks 12, 14 are semi-circular shaped cavities 52, although cavities of any other shape will also work.

The mount 8 is next described in detail. The mount 8 includes a curved body 60. Projecting from a top side of the curved body 60 is a top panel 62. And projecting from a bottom side of the curved body 60 is a bottom panel 64. Two holes are defined on an undersurface of the top panel 62. Another two holes 66 are defined on an upper surface of the bottom panel 64. A second set of four second members 70 are received in these four holes 66 in the top panel 62 and bottom panel 64 of the mount 8. These four second members 70 are positioned on the mount 8 such that they interact with the first set of four disc magnets 30 to allow the mount 8 to be maintained in the rest position over the support 4. In this embodiment, each second member 70 is a disc magnet 70 like those disc magnets 30 used in the support 4. When received in a hole 66, a top surface of the disc magnet 70 is at least substantially flush with the surface. The top panel 62 further includes two through holes 72. The bottom panel 64 include another two through holes 72.

Four holes 74 are further defined in the curved body 60 on a side of the curved body 60 that is opposite to that of the top panel 62 and the bottom panel 64. Each of these four holes 74 is located close to a respective corner of the curved body 60, but they may be located anywhere on the curved body 60. These holes 74 receive as third set of disc magnets 76, such as those disc magnets 30, 70 described earlier. A groove 78 is defined in a medial portion of the curved body 60. A reed switch 80 is received in the groove 78.

The bumper plate 10 is next described in detail. The bumper plate 10 includes a front portion 82, and a first side portion 84 and a second side portion 86 extending rearwardly from the two ends of the front portion 82. Four holes 88 are defined on an inner surface of the front portion 82 of the bumper plate 10. The holes 88 receive a fourth set of disc magnets (not shown) liked those disc magnets 30, 70, 76 described earlier. A fifth hole 90 is defined on the inner surface and this fifth hole 90 likewise receives a disc magnet (not shown). The support 4, the mount 8 and the bumper plate 10 may be molded out of ABS plastic or other non-magnetic materials including but not limited to polylactic acid (PLA) plastic, acetal plastic (e.g. Delrin, a trademarked product from DuPont), aluminum, rubber with a reasonably high shore hardness, etc.

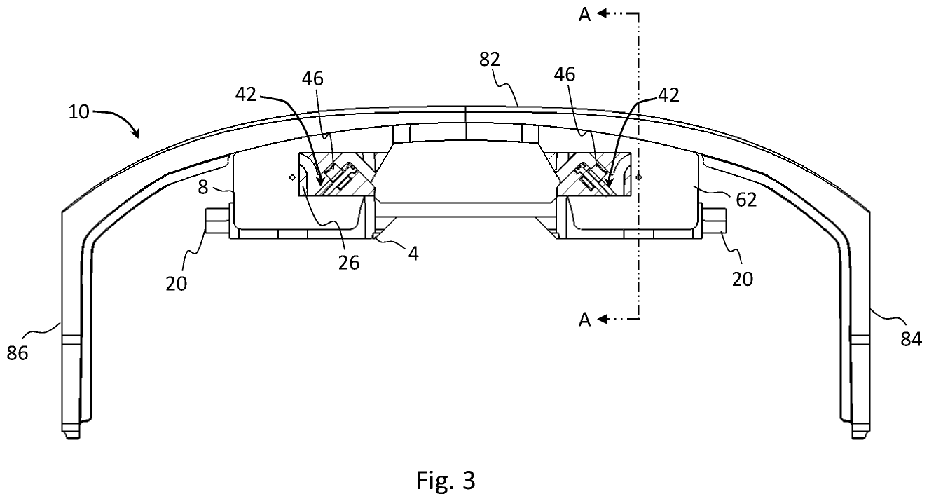

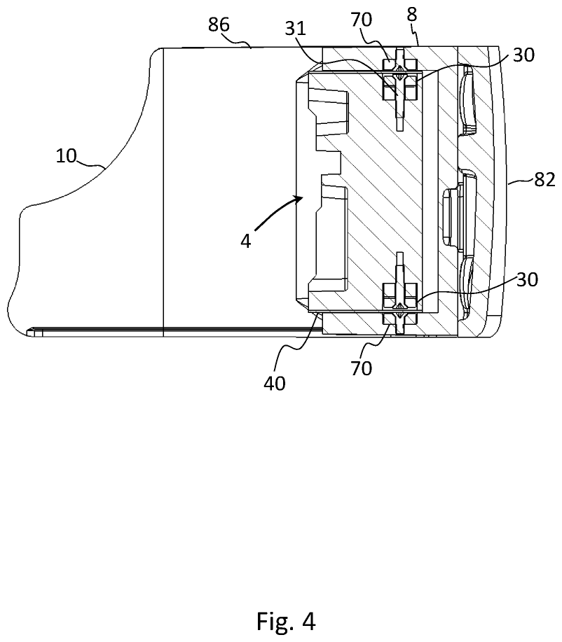

During assembly, the support 4 and the mount 8 are brought together such that the support 4 is received in a space between the top panel 62 and the bottom panel 64 of the mount 8. Magnetic attraction between the first set of four disc magnets 30 of the support 4 and corresponding second set of four disc magnets 70 of the mount 8 will hold the support 4 in place between the top panel 62 and the bottom panel 64 of the mount 8. In other words, the first set of disc magnets 30 and the second set of disc magnets 70 will ensure the mount 8 stays in the rest position over the support 4 as shown in FIG. 4. To effect magnetic attraction, each pair of magnets 30, 70 directly facing each other will have outwardly facing poles that are opposite. When held in this rest position, the mount 8 is detachably mounted to the support 4 so that it is slideable thereover in an XY-plane. In this rest position of the mount 8, the through holes 72 in the top panel 62 and the bottom panel 64 of the mount 4 are also aligned over respective cavities 52 of the support 4. Cap head screws 94 of a length longer than a length of the through hole 72 are inserted into the four through holes 72 in the mount 8. An end of each cap head screw 94 will project into the respective cavity 52 in the support 4. In this manner, the support 4 is secured in place between the top panel 62 and the bottom panel 64 of the mount 8, and the support 4 and the mount 8 cannot be separated without first removing these four cap head screws 94. In this rest position of the mount 8, the raised portion 26 is also spaced apart from an inner surface of the curved body 60 of the mount 8 to provide clearance for the mount 8 to move rearwardly towards the support 4 as shown in FIG. 3. And with the protruding end of the cap head screw 94 of the mount 8 free to move only within the confines of the respective cavity 52 of the support 4, movement of the mount 8 with respect to the support 4 in the XY-plane is thereby restricted. In the rest position of the mount 8, each actuating lever 46 is biased outwards by the respective helical spring 48 so that light emitted by the light transmitter of the optoelectronic sensor 44 is not blocked but allowed to reach the light emitter to indicate the mount 8 is in the rest position.

The bumper plate 10 is attached to the mount 8 by aligning the third set of disc magnets 76 on the mount 8 with the corresponding fourth set of disc magnets (not shown) on the bumper plate 10. Magnetic attraction between the two sets of disc magnets 76 will cause the bumper plate 10 to be detachably mounted to the mount 8. When mounted in this manner, the fifth disc magnet (not shown) of the bumper plate 10 that is adjacent the reed switch 80 of the mount will cause the reed switch 80 to be actuated. This actuation of the reed switch 80 indicates that the bumper plate 10 has been properly mounted to the mount 8.

During use, the bumper system 2 is mounted to a front of a device 22, such as a robotic device 22 shown in FIG. 5, via the laterally extending protrusions 20 of the support 4. The robotic device 22 reads the status of the reed switch 80. If the status of the reed switch 80 indicates that it has been actuated as a result of the bumper plate 10 being mounted to the mount 8, the robotic device 22 can then proceed to move about to perform its chores, such as but not limited to cleaning, vacuuming, mopping, transporting goods, disinfecting, etc. If the status of the reed switch 80 indicates that it has not been actuated, the robotic device 22 may prompt a user, for example via a suitable error or warning message on a display of the robotic device 22, to install the bumper plate 10 before allowing it to move. As the robotic device 22 moves about on the ground, it may run into any obstacle that is in its path. The obstacle may be directly in front of the robotic device 22 or towards one side of the robotic device 22. The robotic device 22 knows that it has run into an obstacle if any one of the optoelectronic switches 44 is detected to be actuated. The robotic device can detect the direction of movement of the bumper plate 10 and mount 8 so as to determine the location of the obstacle by detecting which of the optoelectronic sensors 44 are actuated. If both optoelectronic sensors 44 are detected to be actuated at the same time as a result of the front portion 82, which is a medial position, of the bumper plate 10 hitting the obstacle, that would indicate to the robotic device 22 that the obstacle is at least substantially in front of the robotic device 22. The robotic device may then move away accordingly to avoid the obstacle. If, however only one of the two optoelectronic sensors 44 is actuated as a result of one of the two side portions 84, 86 of the bumper plate 10 hitting the obstacle, that would indicate to the robotic device 22 that the obstacle is towards, and therefore force is applied to, one side of the robotic device 22 and the robotic device 22 can then adjust its position accordingly. For example, if the second side portion 86 of the bumper plate 10 hits the obstacle, the mount 8 will be pushed towards the right as a result of a force thereon to actuate only the left optoelectronic sensor 44. And if the first portion 84 of the bumper plate 10 hits the obstacle, the mount 8 will be pushed in an opposite direction towards the left to actuate only the right optoelectronic sensor 44. After hitting an obstacle, the robotic device 22 will adjust its position until both optoelectronics sensors 44 are detected to be no longer actuated. This happens when the robotic device 22 moves away from the obstacle and the force is no longer applied to the bumper plate 10. As mentioned previously, movement of the mount 8 and bumper plate 10 with respect to the support 4 is restricted, and this ensures that when the force is removed from the bumper plate 10, there is sufficient magnetic attraction between the first set of disc magnets 30 on the support 4 and the second set of disc magnets 70 to return the mount 4 and the bumper plate 10 back to the rest position.

Advantageously, the bumper system 2 is void of springs and therefore simple in design and of relatively low cost. Regardless of the direction in which the bumper plate 10 is pushed, the magnetic attraction between the disc magnets 30, 70 allows the bumper plate 10 to be returned to the rest position. The positioning of the optoelectronic sensors 44 also allow the use of just two sensors 44 to detect an obstacle to the left, centre and right of the bumper plate 10. Unlike springs, which have a limited cycle lifespan, magnets only lose a small fraction of its usable force in about a hundred years. A bumper system 2 using magnets is thus more durable.

Although the present invention is described as implemented in the above described embodiment, it is not to be construed to be limited as such. It is to be appreciated that modifications and improvements may be made without departing from the scope of the present invention.

For example, although sets of four magnets are described to be used on each of the support, the mount and the bumper plate in the embodiment in FIG. 1, a different number of magnets such as one, two, three or more than five may also be used. Each magnet may also be of a different shape, size and strength than a disc magnet 30.

As another example, magnetic attraction between a first member and a second member is described as being provided by two corresponding disc magnets 30, 70. However, those skilled in the art will appreciate that either the first member 30 or the second member 70 may be of a magnetic metal instead. This magnetic metal may include, but not limited to, iron, cobalt, nickel, etc.

As yet a further example, the two sensors 44 for detecting the position of the mount 8 may be any sensor other than optoelectronic sensors 44. For example, electromechanical limit switches and other similar sensors, such as proximity sensors, may also be used. The sensors 44 may also not be limited to be located on the support 4 as described. One or both sensors 44 may be located on the mount 8 instead. In other embodiments, more of less than two sensors may be used. In some embodiments, only one sensor that is able to detect impact from multiple different directions may be used.

As yet another example, the bumper 6 in the embodiment is described to be of two separate parts, i.e., the bumper plate 10 coupled to the mount 8. However, in other embodiments, the bumper plate 10 and the mount 8 may be integrally formed.

As yet a further example, the bumper system 2 may be of any dimensions, ranging anywhere from a few centimetres to metres.

As another example, although the bumper system 2 is described to be used on a robot 22, it is not to be construed to be limited as such. The bumper system 2 may be used in any moving device such as, but not limited to, an autonomous cleaning robot, a self-driving vehicle, an automated guided vehicle, a car, an automatic door, a tactile floor depression sensing device, a production line conveyor belt for detecting objects thereon that may come from any direction.

It should be further appreciated by the person skilled in the art that one or more of the above modifications or improvements, not being mutually exclusive, may be further combined to form yet further embodiments of the present invention.

1. A bumper system comprising:
a support including at least one first member;
a bumper including at least one second member, the bumper being maintainable by the support in a rest position with respect to the support due to magnetic attraction between the at least one first member and the at least one second member when no force is applied to the bumper, and dislodgeable from the rest position towards the support when a force is applied to the bumper, and wherein when the force is removed from the bumper, the magnetic attraction between the at least one first member and the at least one second member returns the bumper to the rest position; and
at least one sensor mounted to one of the support and the bumper for detecting dislodgement of the bumper from the rest position.

2. The bumper system according to claim 1, wherein the bumper comprises:
a mount including the at least one second member; and
a plate detachably mounted to the mount.

3. The bumper system according to claim 2, wherein the plate is detachably mounted to the mount via at least one magnet on one of the mount and the plate.

4. The bumper system according to claim 1, wherein the bumper system has a central axis, wherein the at least one first member includes four first members, and the at least one second member includes four second members, wherein two of the four first members are positioned on either side of the central axis on a first surface of the support, and the other two of the four first members are positioned on either side of the central axis on a second surface of the support opposite the first surface, and the four second members are positioned on the bumper such that they interact with the four first members to allow the bumper to be maintained in the rest position.

5. The bumper system according to claim 1, wherein the at least one sensor comprises two sensors positioned on either side of the central axis on one of the support and the bumper, and wherein both sensors are actuatable when the force is applied to a medial position of the bumper, and only one sensor is actuatable when the force is applied to a side of the bumper.

6. The bumper system according to claim 5, wherein the two sensors are mounted to surfaces of one of the support and the bumper that are angularly inclined with respect to the central axis.

7. The bumper system according to claim 1, wherein movement of the bumper with respect to the support is restricted to ensure that when the force is removed from the bumper, there is sufficient magnetic attraction between the at least one first member and the at least one second member to return the bumper to the rest position.

8. The bumper system according to claim 7, wherein one of the support and the bumper includes a cavity therein and the other of the support and the bumper includes a projection that projects into the cavity and movement of the projection is restricted to within a boundary of the cavity to thereby restrict movement of the bumper with respect to the support.

9. The bumper system according to claim 1, wherein at least one of the first member and the second member is a magnet.

10. The bumper system according to claim 9, wherein the magnet is of about N45 maximum energy product.

11. A device comprising:
a body; and
a bumper system attached to the body, the bumper system comprising:
a support including at least one first member;
a bumper including at least one second member, the bumper being maintainable by the support in a rest position with respect to the support due to magnetic attraction between the at least one first member and the at least one second member when no force is applied to the bumper, and dislodgeable from the rest position towards the support when a force is applied to the bumper, and wherein when the force is removed from the bumper, the magnetic attraction between the at least one first member and the at least one second member returns the bumper to the rest position; and
at least one sensor mounted to one of the support and the bumper which is actuatable when the bumper is dislodged from the rest position.

12. The device according to claim 11, wherein the bumper comprises:
a mount including the at least one second member; and
a plate detachably mounted to the mount.

13. The device according to claim 12, wherein the plate is detachably mounted to the mount via at least one magnet on one of the mount and the plate.

14. The device according to claim 11, wherein the bumper system has a central axis, wherein the at least one first member includes four first members, and the at least one second member includes four second members, wherein two of the four first members are positioned on either side of the central axis on a first surface of the support, and the other two of the four first members are positioned on either side of the central axis on a second surface of the support opposite the first surface, and the four second members are positioned on the bumper such that they interact with the four first members to allow the bumper to be maintained in the rest position.

15. The device according to claim 11, wherein the at least one sensor comprises two sensors positioned on either side of the central axis on one of the support and the bumper, and wherein both sensors are actuatable when the force is applied to a medial position of the bumper, and only one sensor is actuatable when the force is applied to a side of the bumper.

16. The device according to claim 15, wherein the two sensors are mounted to surfaces of one of the support and the bumper that are angularly inclined with respect to the central axis.

17. The device according to claim 11, wherein movement of the bumper with respect to the support is restricted to ensure that when the force is removed from the bumper, there is sufficient magnetic attraction between the at least one first member and the at least one second member to return the bumper to the rest position.

18. The device according to claim 17, wherein one of the support and the bumper includes a cavity therein and the other of the support and the bumper includes a projection that projects into the cavity and movement of the projection is restricted to within a boundary of the cavity to thereby restrict movement of the bumper with respect to the support.

19. The device according to claim 11, wherein at least one of the first member and the second member is a magnet.

20. The device according to claim 11, wherein the device is one of a robot, an autonomous cleaning robot, a self-driving vehicle, an automated guided vehicle, a car, an automatic door, a tactile floor depression sensing device, and a production line conveyor belt.
